(19) United States
(12) Patent Application Publication
(10) Pub. No.: US 2012/0239525 A1
(43) Pub. Date: Sep. 20, 2012

(54) SYSTEM AND METHOD FOR GENERATING QUANTITATIVE GUIDELINE FOR PRINT ORDER

(75) Inventors: Jun Zeng, Sunnyvale, CA (US); Eric Hoarau, San Francisco, CA (US); Giordano B. Beretta, Palo Alto, CA (US); I-Jong Lin, Half Moon Bay, CA (US)

(73) Assignee: Hewlett-Packard Company, Fort Collins, CO (US)

(21) Appl. No.: 13/051,936

(22) Filed: Mar. 18, 2011

(51) Int. Cl. G06Q 30/00

(52) U.S. Cl. 705/26.8

(57) ABSTRACT

Systems and methods for determining a quantitative guideline are provided. One such method may involve receiving into an electronic device a print order from a customer to a print service provider, determining the requisite tasks to fulfill the print order, determining which resources of the print service provider are capable of undertaking the requisite tasks, and determining respective costs and lead times associated with undertaking each requisite task using each capable resource. In particular, such costs and lead times may be determined based at least in part on a dynamic behavioral model of cost and a dynamic behavioral model of lead time associated with each resource.

### BACKGROUND

Despite the onset of the “electronic age,” there is still significant demand for print products. Indeed, commercial print often may have annual retail sales totaling more than $700 billion. Print service providers (PSPs) fulfill the demand for print products by printing a vast array of print products, such as photographs and brochures, school course materials, periodicals and books, and advertisements and product packaging.

Today, operation managers tend to negotiate a price and due time for a print order, as well as select the machines used to fulfill the order, based on their experience with the print factory and print industry, basic spreadsheets, mental models, and intuition. Although intuition alone may suffice to reach an acceptable price and due time for some orders, a human operation manager may occasionally negotiate a price and due time, and/or select a combination of machines to fulfill a print order, that is unprofitable. Moreover, although some electronic tools have been developed to determine a price and due time associated with fulfilling a given print order, these electronic tools may rely on static models and/or may be very expensive and complex. In fact, some of these electronic tools even may require dedicated specialists to use.

### BRIEF DESCRIPTION OF THE DRAWINGS

FIG. 1 is a schematic block diagram illustrating a print order transaction between a customer and a print service provider (PSP), in accordance with an embodiment;

FIG. 2 is a schematic block diagram illustrating a determination of a pricing guideline to assist with the negotiation and/or fulfillment of a print order, in accordance with an embodiment;

FIG. 3 is a flowchart describing an embodiment of a method for determining a pricing guideline to assist with negotiation and/or fulfillment of a print order;

FIG. 4 is a schematic diagram representing an example of a print order, in accordance with an embodiment;

FIG. 5 is a schematic block diagram representing a task fulfillment graph illustrating requisite tasks to fulfill a print order, in accordance with an embodiment;

FIG. 6 is a schematic block diagram representing one task of the task fulfillment graph of FIG. 5, in accordance with an embodiment;

FIG. 7 is a is a schematic block diagram describing a resource of a print factory of a PSP, in accordance with an embodiment;

FIG. 8 is a plot comparing total costs and lead times of various possible fulfillment paths using resources of a print factory to fulfill a print order, in accordance with an embodiment; and

FIG. 9 is a plot illustrating a pricing guideline to assist with the negotiation and/or fulfillment of a print order, based on the plot of FIG. 8.

### DETAILED DESCRIPTION

Selecting an appropriate price and due time for a print order may depend heavily on the changing conditions of print factory resources. As such, the present disclosure relates to techniques for automatically generating pricing and/or fulfillment guidance for a proposed print order using behavioral models of resources that dynamically capture the current situation of the print factory, a predicted situation of the print factory at the time of printing, and/or a predicted future situation. Using the presently disclosed techniques, a print service provider (PSP) can obtain quantitative assistance for both order negotiation and the selection of the print factory resources to fulfill the order once the print order is admitted.

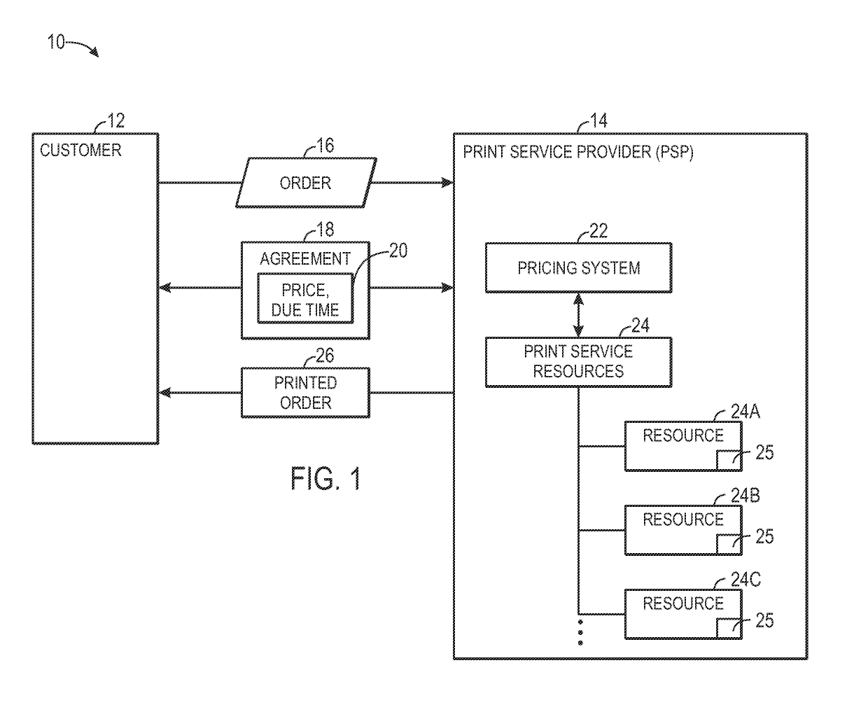

With the foregoing in mind, FIG. 1 represents a print order transaction 10 between a customer 12 and a print service provider (PSP) 14. The customer 12 may represent, for example, an individual, a group of individuals, or an organization (e.g., a nonprofit corporation, a small business, a large corporation, and so forth). The PSP 14 may process print orders 16 received from a variety customers, such as the customer 12. By way of example, the customer 12 may be a retail storefront on the Internet that sells books, photo books, posters, calendars, and so forth, which may be requested by individual consumers.

The customer 12 may submit a print order 16 to the PSP 14. The print order 16 may represent an order that includes a print product requested by the customer 12, in some cases on behalf of a consumer purchasing the product from the customer 12 (e.g., via a retail Internet storefront). The customer 12 and the PSP 14 may reach an agreement 18 including an agreed-upon price and due time 20, sometimes referred to as a (price, due time) data pair 20, for fulfillment of the print order 16.

The negotiation process to determine the agreement 18 may address several questions or concerns of the customer 12 and the PSP 14. On the customer 12 side, for example, the customer 12 may indicate a threshold level of product quality that is expected, when the print order 16 is to be fulfilled, and how much the customer 12 is willing to pay. On the PSP 14 side, the PSP 14 may consider whether the PSP 14 is capable of fulfilling the print order 16, how soon the print order 16 could be fulfilled and how much it will cost the PSP 14 to fulfill the print order 16, and what the profit margin on fulfillment of the print order 16 will be.

The PSP 14 may employ a pricing system 22 that may help to answer some of these questions to assist with the determination of the agreement 18. It should be noted that the customer 12 may employ a similar system. The pricing system 22 may determine a pricing guideline comparing possible costs and lead times associated with fulfilling the print order 16 using various combinations of the print service resources 24 of the PSP 14.

These print service resources 24 may include a number of machines and/or workers that could possibly be used to fulfill the print order 16. These various print service resources 24 are generally illustrated as 24A, 24B, and 24C, but are not limited to only three resources. The various print service resources 24 may perform various production operations, including pre-press production, press production, and post-press production. During pre-press production, the print order 16 may be converted to the requisite format (e.g., an electronic bitmap file). During press production, the print order 16 may be printed by the printing machines of the PSP 14. During post-press production, the print order 16 may be finished by laminating, cutting, collating, binding, sorting/binning, packaging, and shipping. In addition, quality assurance (QA) may also be implemented during at least one of these production operations. Moreover, the production operations may include automated processes and/or manual processes, representing operators as well as their respective line managers. Indeed, at each stage of the fulfillment of the print order 16, multiple resources of the print service resources 24, including machines and workers, may be available to provide the same function but may have different availability, capabilities, and capacity. These differences may affect the cost and lead times associated with using certain of the print service resources 24 over others.

Rather than rely on static models of the print service resources 24, the pricing system 22 may determine predicted costs and lead times associated with fulfilling the print order 16 with different print service resources 24 using behavioral models of the print service resources 24. These behavioral models may more effectively ascertain a likely cost and lead time associated with fulfilling the print order 16 than static models. In particular, the behavioral models may take into account the dynamic behavior of the various print service resources 24 as usage statuses of the resources vary depending on the priority assigned to fulfilling the print order 16 (e.g., normal priority or high priority). To determine predicted costs and lead times for fulfilling the print order 16, the behavioral models may also take into account the predicted workload already assigned to a print service resource 24 at the time of printing; this workload information can be predicted by simulation, a user knowledge base, and/or statistical modeling using historical factory sensing data obtained from a manufacturing execution system (MES) or from a sensing mechanism (e.g., 25) installed on the resource 24. The behavioral models may also take into account the process variation of a resource in terms of process performance, quality, and cost (e.g., historical performance data, analysis, manufacturer specification, user test, and/or user input). The behavioral models may also take into account the likelihood of the interruption of the print service resources 24, such as scheduled maintenance, possible ink/paper change/replenishment, and other types of deterministic and non-deterministic interruptions such as mechanical failures. By relying on such behavioral models, a comparison of costs and lead times associated with all possible fulfillment paths and priorities to fulfill the print order 16 can be obtained. From such a comparison of the possible costs and lead times of the fulfillment paths to fulfill the print order 16, the PSP 14 may select a price and due time 20 most acceptable to the customer 12 that can provide the greatest profit and may determine the most cost effective fulfillment path through the print service resources 24. This may be facilitated, for example, by polling certain control or monitoring systems 25 associated with individual print service resources 24, such as resources 24A, 24B, and 24C.

As shown in FIG. 1, the core of the agreement 18 may be the (price, due time) data pair 20 that both the customer 12 and the PSP 14 can agree on. Upon reaching the agreement 18, the print order 16 may be admitted by the PSP 14 and fulfilled through a fulfillment path of the print service resources 24 that, according to the pricing system 22, may be the most efficient fulfillment path given the due time constraints of the customer 12. The most efficient fulfillment path may a fulfillment path that costs the least to the PSP 14 but still meets the due time. The printed order 16 then may be fulfilled by the selected print service resources 24 and shipped to the customer 12 as a printed product 26. Alternatively, the printed product 26 may be shipped directly to a consumer or client designated by the customer 12.

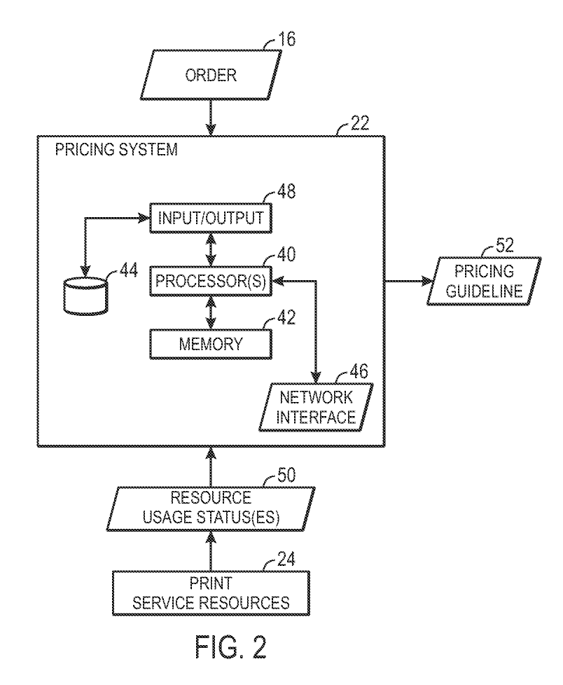

One example of the pricing system 22 appears in FIG. 2. As shown in FIG. 2, the pricing system 22 may represent any suitable computer system capable of performing techniques disclosed herein. The various functional blocks of the pricing system 22 may include hardware elements, processor-executable instructions, or a combination of both. Indeed, the blocks of the pricing system 22 of FIG. 2 are intended to represent only one example of a particular implementation of the pricing system 22. Moreover, these blocks are generally intended to illustrate the types of components that may be present in the pricing system 22.

Processor(s) 40 and/or other data processing circuitry may be operably coupled to memory 42 and storage 44 to perform various algorithms for carrying out the presently disclosed techniques. These algorithms may be encoded in programs and/or instructions that may be executed by the processor(s) 40 and stored in any suitable article of manufacturer that includes at least one tangible, computer-readable media that at least collectively stores the instructions or routines, such as the memory 42 and/or the storage 44. By way of example, the memory 42 and the storage 44 may include any suitable articles of manufacturer for storing data and executable instructions, such as random-access memory, read-only memory, rewritable memory, a hard drive, and optical discs. The network interface 46 may provide communication via a personal area network (PAN) (e.g., Bluetooth), a local area network (LAN) (e.g., Wi-Fi), a wide area network (WAN) (e.g., 3G or LTE), and/or the like, to enable cloud storage, processing, and/or information requests from other networked devices. In addition, the pricing system 22 may include various input/output (I/O) ports 48. As should be appreciated, the pricing system 22 may include a variety of other components, such as a power supply, an electronic display, and/or user interface components (e.g., a keyboard, a mouse, a track pad, a touch screen interface, and so forth).

The pricing system 22 may be a computer system used by the PSP 14 in a dedicated fashion to assist with efficiently selecting pricing and fulfillment of the print order 16, or may itself be, or may be associated with, a system-controlling computer system used by the PSP 14. For example, the pricing system 22 may be integrated with a manufacturing execution system (MES) used by the PSP 14 to control how the print order 16 is fulfilled through the print service resources 24.

The pricing system 22 may receive the print order 16 and resource usage statuses 50 associated print service resources 24 via the network interface 46 and/or the I/O ports 48. By way of example, the pricing system 22 may receive the resource usage statuses 50 from a manufacturing execution system (MES) of the PSP 14, or directly from the machines of the print service resources 24. It should be noted that the resource usage statuses 50 may be provided in real time; driven by machine events such as work arrival, job queue order, work completed, ink/toner low, request to replenish paper, and so forth; or periodically (e.g., every 1 min., 2 min., 5 min., 10 min., 15 min., 20 min., 30 min., 1 hr., 2 hrs., and so forth). For example, an MES of the PSP 14 may receive updated resource usage statuses 50 from the machines of the print service resources 24, and subsequently release new print orders 16 to be fulfilled by the print service resources 24, every 15 minutes or so. After receiving these resource usage statuses 50 from the machines of the print service resources 24, the MES may provide the resource usage statuses 50 to the pricing system 22. These resource usage statuses 50 may include both current statuses and historical (past) statuses. By way of example, the resource usage statuses 50 may indicate an off or on status, a current utilization, a queue jobs profile, and/or a size of a waiting queue of each of the print service resources 24, among other things.

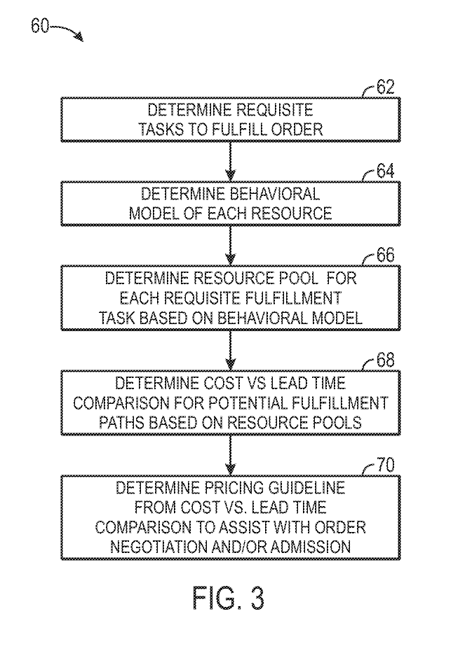

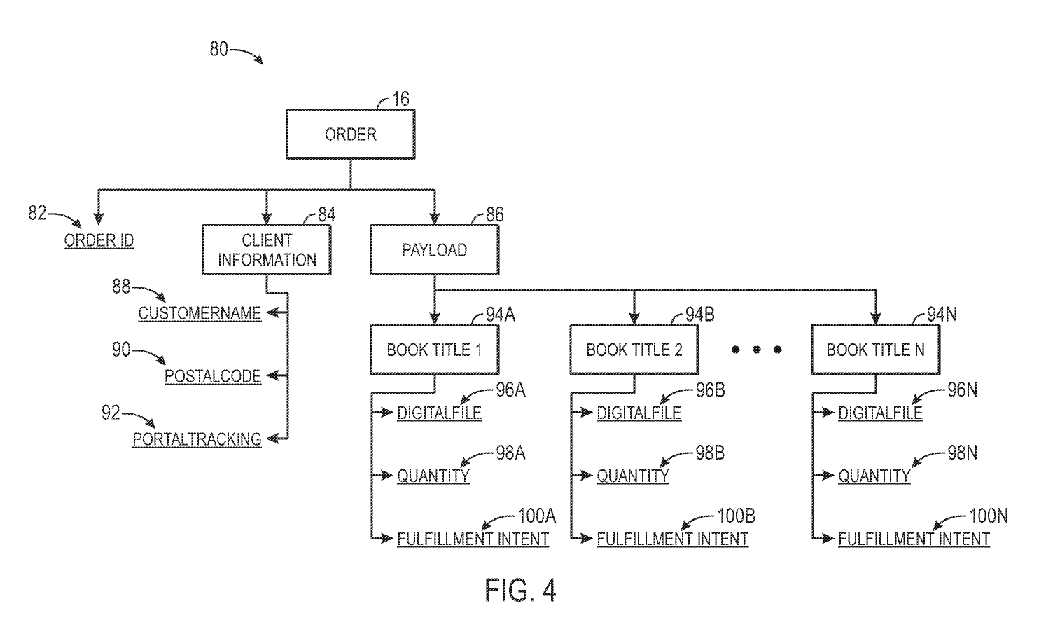

By comparing the fulfillment requirements of the print order 16 with cost and lead time behavioral models determined using the status of print service resources 50, the pricing system 22 may determine a pricing guideline 52 to assist with the negotiation of the price and due time 20 of the agreement 18. One manner in which the pricing system 22 may determine the pricing guideline 52 appears in a flowchart 60 of FIG. 3. The flowchart 60 may begin when the pricing system 22 determines requisite tasks to fulfill the print order 16 (block 62). Ways in which the pricing system 22 may determine the requisite tasks will be described in greater detail below with reference to FIGS. 4-6. In general, determining all of the requisite tasks may involve determining what individual tasks (e.g., printing, trimming, sewing, binding, and so forth) are needed to fulfill the print order. As will be discussed below, each of these requisite tasks may represent one step in the fulfillment of the print order 16, and frequently more than one of the print service resources 24 may be capable of performing each requisite task.

With continued reference to the flowchart 60 of FIG. 3, the pricing system 22 also may determine a behavioral model of cost and a behavioral model of lead time associated with each capability of each of the print service resources 24 of the PSP 14 (block 64). It should be appreciated that these behavioral models may be determined each time a print order 16 is received, at some other times (e.g., periodically), or the behavioral models may be predetermined and/or preset. The behavior model may also be dependent on the job order parameters. One manner of determining such behavioral models will be discussed below with reference to FIG. 7.

The pricing system 22 next may determine, for each requisite task to fulfill the print order 16, a resource pool of the possible print service resources 24 that are capable of performing that requisite task (block 66). Determining each resource pool also may include determining costs and lead times based at least partly on the behavioral models of the print service resources 24. Thus, the pricing system 22 first may determine, for each requisite task, which of the print service resources 24 would be capable of performing that requisite task. A list of those print service resources 24 capable of performing a given requisite task is referred to herein as a “resource pool” specific to that requisite task. Then, the pricing system 22 may calculate, for each resource of the resource pool associated with each requisite task, a cost and a lead time that would be expected to be incurred when that resource performs that requisite task. As noted above, determining cost and lead time associated with performing a given requisite task using a given resource of the print service resources 24 may involve using behavioral models of that resource.

Based on all possible permutations of the resource pools through all the requisite tasks, the pricing system 22 may determine all fulfillment paths that could possibly fulfill the print order 16 (block 68). As such, the pricing system 22 also may determine the possible total costs and lead times associated with each possible fulfillment path. In this way, all possible costs and lead times for fulfillment of the print order 16 may be used to determine the pricing guideline 52 (block 70). As mentioned above, the pricing guideline 52 may indicate the various possible costs associated with fulfilling the print order 16 at different lead times, as well as indicate which of the print service resources 24 would most efficiently fulfill the print order 16. The most efficient fulfillment path may be a fulfillment path that can best meet the operations objective of the PSP 14 and simultaneously meet the due time. The operations objective of the PSP 14 may be minimization of the end-to-end manufacturing cost, balancing cost with operational metrics, and so forth. Thus, the pricing guideline 52 may assist with the order negotiation as well as the admission and fulfillment of the print order 16.

FIGS. 4-6 relate to block 62 of the flowchart 60 of FIG. 3, and relate to determining requisites tasks for fulfilling the print order 16. FIG. 4, in particular, represents one example of information that may be conveyed in the print order 16. It should be appreciated that FIG. 4 provides only one example of the type of information and/or form of organizing a print order 16. However, the print order 16 may be organized in any other suitable manner, and may convey any suitable information useful to the fulfillment of the print order 16. In the example of FIG. 4, an electronic representation 80 of the print order 16 includes an order identification number 82 (OrderID), client information 84, and a payload 86. The order identification number 82 may represent a unique identifying number associated with the print order 16. The client information 84 may represent shipping information to allow the ultimate printed order 26 to be shipped to the customer 12 or the client of the customer 12. For example, the client information 84 may include a specific customer name 88, a postal code 90, and postal tracking information 92 to allow the printed order 26 to be shipped to a client listed in the client information 84.

The payload 86 of the print order 16 may include a request for a number of print products 94, here shown as print products 94A, 94B . . . 94N and represented as different book titles. For each print product 94, a digital file 96 of the print product 94 may be included or a location where the digital file associated with the print product 94 may be obtained (e.g., via a hyperlink to a network source) may be provided. The payload 86 also may indicate a requested quantity 98 of each print product 94. Additionally, for each print product 94, a fulfillment intent 100 may be indicated.

The fulfillment intent 100 may describe the expectation of the client purchasing the print product 94 in terms that the PSP 14 and the client and/or customer 12 may mutually understand. By way of example, in the case of manufacturing a photo book, fulfillment intent may include the following description: (1) dimension and portrait or landscape mode; (2) cover material type (e.g., padded cover or cloth cover); (3) image crop style (e.g., stretch-to-fit); (4) with or without die cut; (5) duplex printing or single-side printing; (6) substrate material type and color; (7) expectation of color quality; (8) type of binding (e.g., perfect bound or hard-case bound); (9) expectation of overall product quality.

Depending on the sophistication and configuration of communication between the customer 12 and the PSP 14, the fulfillment intent 100 may be expressed in different manners. At one end of the spectrum, the fulfillment intent 100 can be purely descriptive and in layman's terms, while at the other end of the spectrum the fulfillment intent 100 can be a detailed list of operations instructions (e.g., which type of machines are requested to complete a particular step in the fulfillment of the print order 16). In a highly automated engagement environment, the fulfillment intent 100 can be documented in the form of an XML file generated by order acquisition software or a record in a database.

It should be appreciated that the content represented by the digital file 96, the quantity 98 of a particular print product 94, as well as the various strictures of the fulfillment intent 100 may impact the various tasks needed to perform fulfillment of the print order 16. Thus, based on the information indicated by the print order 16, the pricing system 22 may determine all the individual tasks requisite to fulfill the print order 16. As mentioned above, and as discussed further below, this determination of the requisite tasks to fulfill the print order 16 may be employed to ascertain costs and lead times associated with different possible fulfillment paths.

Determining the requisite tasks to fulfill the print order 16 may include determining which of the various tasks required to fulfill the print order 16 must be run in series, and which may be run in parallel. The pricing system 22 may make such a determination using any suitable technique that accounts for which tasks must be completed before others may be completed in the fulfillment path to fulfill the print order 16. For example, the pricing system 22 may rely on fulfillment paths that have been selected by the PSP 14 (e.g., predetermined) as part of the workflow solution of the PSP 14, or the pricing system 22 may develop fulfillment paths to complete the order in other manners.

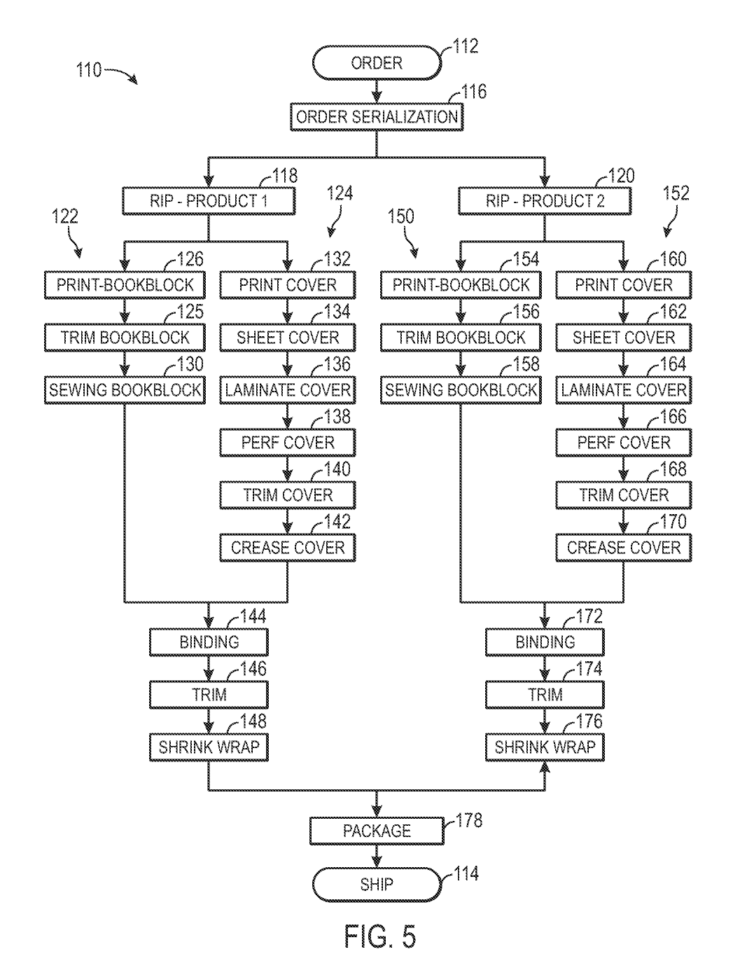

By way of example, the pricing system 22 may develop an order fulfillment task graph 110, an example of which is shown in FIG. 5. In the example of FIG. 5, the order fulfillment task graph 110 provides an example in which two books form the payload 86 of a print order 16. The order fulfillment task graph 110 of FIG. 5 may begin with an order intake 112 and end with the shipping 114 of the completed printed order 26. A variety of requisite tasks may take place between the order intake 112 and the shipping 114 of the completed order, some of which may occur in series and some of which may occur in parallel. It should be noted that each block of the order fulfillment task graph 110 of FIG. 5 represents an individual task required to fulfill the print order 16. Arrows from a first block to a second block indicate that the first task represented by the first block must be completed before the task represented by the second block can begin.

In the example of FIG. 5, following the order intake 112, the PSP 14 may serialize the fulfillment of the print products 94 of the print order 16 (block 116). That is, the order of performing the various tasks to fulfill the print order 16 may be determined. As such, following the serialization of the print products 94, which may result, in the example of FIG. 5, in two book titles being manufactured in parallel, a first raster image processing (RIP) 118 may take place for the first book, and a second raster image processing (RIP) 120 may take place for the second book.

After the RIP 118, the manufacturing of the first book may involve manufacturing a book block (process 122) and manufacturing a book cover (process 124). Manufacturing the book block in the process 122 may involve, for example, printing the book block from the rasterized image (block 126), trimming the book block (block 128), and sewing the book block together (block 130). Manufacturing the book cover in the process 124 may involve, for example, printing the cover (block 132), sheeting the cover (block 134), laminating the cover (block 136), perforating the cover (block 138), trimming the cover (block 140), and creasing the cover (block 142). The book block and book cover then may be bound together (block 144), trimmed (block 146), and shrink-wrapped (block 148).

Potentially occurring in parallel to the manufacture of the first book, manufacturing the second book following the RIP 120 may take place in substantially the same way. In the example of FIG. 5, processes and tasks represented by blocks 150-176 to manufacture the second book generally correspond respectively to the processes and tasks represented by blocks 122-148 to manufacture the first book. Having manufactured and shrink-wrapped the first book and the second book of the print order 16, the two books may be packaged (block 178) and shipped (block 114).

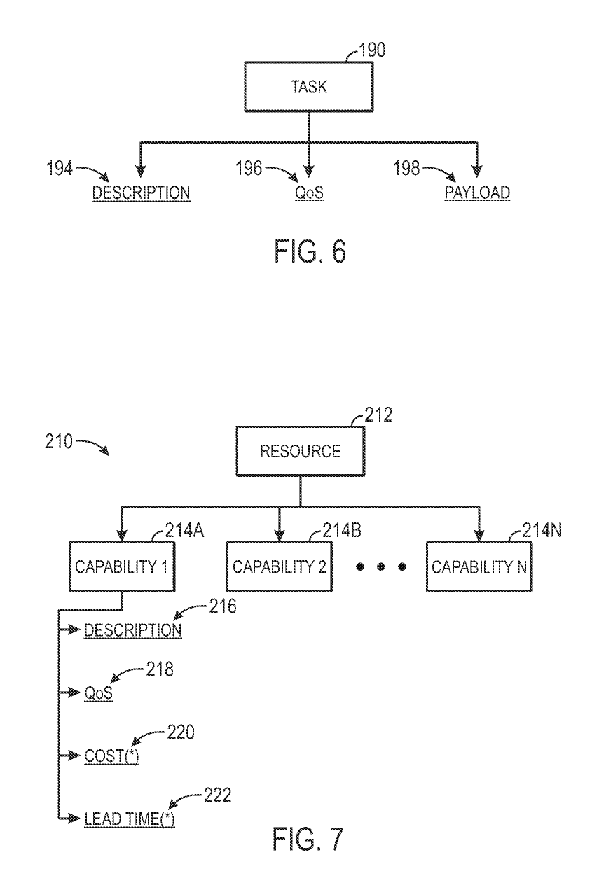

Each node of the order fulfillment task graph 110 may represent a task 190, as generally represented by FIG. 6. Specifically, each task 190 may include a description 194, a minimum quality of service (QoS) 196, and an indication of the payload 198 output by the task 190. The description 194 of the task 190 may be, for example, a string that describes what the task 190 will need to perform (e.g., “color print”). The payload 198 may specify the amount work needed to be completed (e.g., “50 pages; A4; cream paper; 6 color”). The task QoS 196 may specify the minimum quality requirement that accords with the fulfillment intent 100 of the print order 16. As will be discussed below, the description 194 and the QoS 196 may together determine the potential pool of resources of the print service resources 24 that could potentially fulfill the task 190. The payload information 198 may be used to calculate the lead time and the cost associated with each of the pool of resources of the print service resources 24 that could fulfill the task 190.

To determine a behavioral model of cost and lead time of each resource of the print service resources 24, as generally mentioned above with reference to block 64 of FIG. 3, the pricing system 22 may consider a variety of information. Such information may include information 210 schematically represented by FIG. 7. As should be appreciated, the pricing system 22 may alternatively employ any suitable manner of ascertaining behavioral models of the resources 212 of the print service resources 24. For example, the network interface 46 of FIG. 2 can be used to combine information from multiple sites owned by a PSP 14 or an industry information database. The information 210 of FIG. 7 is intended only to represent the type of information about each resource 212 of the print service resources 24 that may be known by the pricing system 22. Indeed, more or less information about the resources 212 may be known or used by the pricing system 22.

In the example of FIG. 7, each resource 212 of the print service resources 24 is shown to have a variety of capabilities 214, represented here as capabilities 214A, 214B, . . . 214N. That is, each resource 212 may have a variety of capabilities 214. These capabilities 214 may include, for example, fully automated processes (e.g., raster image processing (RIP) software) or capabilities 214 requiring a worker. By way of example, a capability 214 that may require a worker may include a printing press (monitored by a worker) or a sewing machine (requiring a worker to work on it). Various other capabilities 214 could include, for example, printing in black and white, color, high-resolution color, medium format printing, trimming, collating, and so forth.

Each capability 214 may be represented by a description 216, a quality of service (QoS) 218, a cost 220, and a lead time 222. The description 216 and the QoS 218 generally may share the same vocabulary as used in representing each requisite task 190 as determined at block 62 of FIG. 3. Specifically, a description 216 associated with a capability 214 may correspond to a description 194 associated with a task 190. Likewise, a QoS 218 may correspond to a QoS 196 associated with a task 190. When the description 216 and QoS 218 of a capability 214 correspond with the description 194 and the QoS 196 of a given task 190, (e.g., when the description 194 equals or is a subset of the description 216 and the QoS 196 equals or is a subset of the QoS 218) the pricing system 22 may determine that resource 212 can perform the task 190.

Although a resource 214 may be capable of performing a task 190, it may not necessarily be cost effective and/or sufficiently quick to meet the due time. As such, a model of cost 220 and a model of lead time 222 associated with each capability 214 of each resource 212 may be determined. Rather than relying on static models, however, the pricing system 22 may employ behavioral models of the print service resources 24 to dynamically determine cost and lead time using, for example, the resource usage statuses 50. Specifically, inputs to these behavioral models may include the state of the resource 212 (e.g., the resource usage status 50 of the resource 212, which may indicate the utilization and/or size of the waiting queue for existing orders 16 being fulfilled by the PSP 14) and possible priority assigned to a given task 190.

The state of the resource 212 can be estimated by a direct measurement of the resource 212 by way of the status of print service resources 50, through simulation, or through a dynamic forecasting model. By way of example, one component of a behavioral model for determining the cost 220 and/or lead time 222 of a capability 214 of a resource 212 may be a faulty rate model. A faulty rate model can be derived from simulation, statistical modeling, queuing network theory, user input, and/or measurement. In general, for example, the faulty rate may vary from resource 212 to resource 212, and, indeed, from capability 214 to capability 214 even belonging to the same resource 212. To provide one example, the faulty rate of one capability 214 may be a function of utilization rate that is relatively low and relatively steady until a certain degree of utilization occurs, at which point the faulty rate may increase exponentially.

The behavioral model of cost 220 also may vary depending, for example, on whether a task 190 is to be given a normal or high priority. If a capability 214 is to perform a task 190 at a normal priority, the cost may be represented by the following relationship:

Cost(*)=work_time*(rate_cost+worker_demand*rate_cost_worker)*(1+faulty_rate) (1).

In the case that the capability 214 is to perform a task 190 that is given high priority, thereby jumping in front of other orders 16 in the queue to the resource 212, the cost 220 may be represented by the following relationship:

$$Cost ( \text{*} ) = work\_time * ( \begin{matrix}rate\_cost + worker\_demand * rate\_cost \_worker + \\ rate\_opportunity \_cost * size\_of \_waiting \_queue\end{matrix} ) * ( 1 + faulty\_rate ) . \qquad ( 2 )$$

In Equations 1 and 2 above, each variable represents a statistical quantity that can be derived from historical records, modeling, simulation, and so forth. For example, in some embodiments, each variable may be expressed by a mean value and a standard deviation, or other means to express a statistical variable. Additionally or alternatively, each variable may include a weight parameter that quantifies the contribution of that variable to the total cost. The variable rate_cost_worker may represent a PSP 14 worker's total compensation (salary, benefit, paid vacation, and others) distributed over total work time. This is the effective cost rate of engaging a worker during the fulfillment of the task 190 using the resource 212. The variable work_time may represent the time required to fulfill the task 190 using the resource 212 (as may be indicated by the payload 198 of the task 190). The variable worker_demand may represent a percentage of work time requiring worker's assistance. For instance, a sewing machine may require 100% of the worker's time. Other printing machines may require, for example, 50% of the worker's time (e.g., the worker may work on two such printing machines at once). The variable rate_cost has two components. The first is the baseline cost, including capital depreciation, rent, electricity, insurance, and more. The other component is the working cost, which refers to additional cost incurred by fulfilling this task 190 using the resource 212. For instance, when the resource 212 is a printing press, this working cost will include the cost of consumables, cost of ink, cost of substrate, and more, of completing the requisite task 190. The variable rate_opportunity_cost is used in Equation 2 in the case where the task 190 is to be given high priority in the resource 212, jumping to the front of the queue and delaying other jobs. As such, this variable may represent a function estimating the cost of delaying the jobs in the queue. One conservative estimate can be the rate of a late penalty multiplied by the work time. The variable faulty_rate may represent a faulty rate model derived from simulation, statistical modeling, and/or measurement. For example, the faulty rate of one capability 214 may be a function of utilization rate that is relatively low and relatively steady until a certain degree of utilization occurs, at which point the faulty rate may increase exponentially.

As should be understood, the behavioral models of cost illustrated in Equations 1 and 2 are not intended to be exhaustive. Indeed, behavioral models of cost may take into account more or fewer factors to predict the cost of completing a task 190. To provide a few examples, effects of a random event and/or perceived risk may also be included as variables of either or both Equations 1 and 2.

Likewise, the lead time 222 may be determined based on behavioral models that vary depending on whether the print order 16 is given normal priority or high priority. By way of example, the lead time 222 may be represented by the following relationship:

Lead_time(*)=wait_time+work_time*(1+faulty_rate) (3).

In Equation 3, the variable wait_time represents the time spent waiting behind a queue of other jobs to be carried out by the resource 212 and the variable work_time represents the time required to fulfill the task 190 using the resource 212 (as may be indicated by the payload 198 of the task 190). The variable faulty_rate may represent a faulty rate model derived from simulation, statistical modeling, and/or measurement. For example, the faulty rate of one capability 214 may be a function of utilization rate that is relatively low and relatively steady until a certain degree of utilization occurs, at which point the faulty rate may increase exponentially.

In the case that a task 190 is to be given high priority, and therefore is allowed to jump in front of the queue of other jobs waiting for the resource 212, the wait time (wait_time) is essentially zero. In the case that the task 190 is to be given normal priority, and therefore must wait in the queue, the wait time may be modeled through simulation, extraction from past historical data, and/or queuing network theory. The variable wait_time may be a function of the content of each job (what needs to be done), the setup time (which is usually a function of the job sequence), and other factors that may affect the time to process the jobs in the queue that are in front of this task. As an example to illustrate, the behavioral model of the wait time (wait_time) may be a function of the size of the waiting queue: it may be linearly proportional to the queue size when it is small, but may grow exponentially when the queue size is large.

Having determined the requisite tasks (e.g., all of the tasks 190 of the task fulfillment graph 110) to fulfill the print order 16 and behavioral models of the resources 212, the pricing system 22 may determine respective resource pools of the print service resources 24 that can be used to perform each requisite task 190 (e.g., as noted above with reference to block 66 of the flowchart 60 of FIG. 3). Specifically, for each task, the pricing system 22 may consider some or all of the resources 212 of the PSP 14, identifying possible resources 212 that can fulfill the given task 190. In general, the criteria to qualify a resource 212 to perform a given task 190 may be that the description 216 of a capability 214 of the resource 212 is the same as a description 194 of a requisite task 190, and that the QoS 218 of the capability 214 of the resource 212 is greater than or equal to the QoS 196 of that task 190. As noted above, all of the possible resources 212 of the print service resources 24 that may be used to perform a given requisite task 190 are referred to herein as a “resource pool” associated with that requisite task 190. In some embodiments, the pricing system 22 may identify possible resources 212 that can fulfill a given requisite task 190 by following a fulfillment path selected by the PSP 14 (e.g., a selected fulfillment path in a workflow determined by the PSP 14).

For every resource 212 that is qualified to perform a task 190 (i.e., for each resource 212 of the resource pool associated with that task 190), an expected cost 220 and lead time 222 may be determined using the behavioral models for the cost 220 and the lead time 222. In so doing, possible costs 220 and lead times 222 for performing the given requisite task 190 may be determined. In some embodiments, this process may be repeated for every requisite task 190.

By determining certain permutations of the resources 212 of the resource pools associated with each requisite task 190 that can be used to fulfill the print order 16, some potential fulfillment paths may be determined. For example, the pricing system 22 may be used to determine all permutations of the resources 212 of the resource pools associated with each requisite task 190 that can be used to fulfill the print order 16, and thus may determine all potential fulfillment paths. In other cases, the pricing system 22 may only determine fulfillment paths that have been selected by the PSP 14 (e.g., a preselected subset of all possible fulfillment paths).

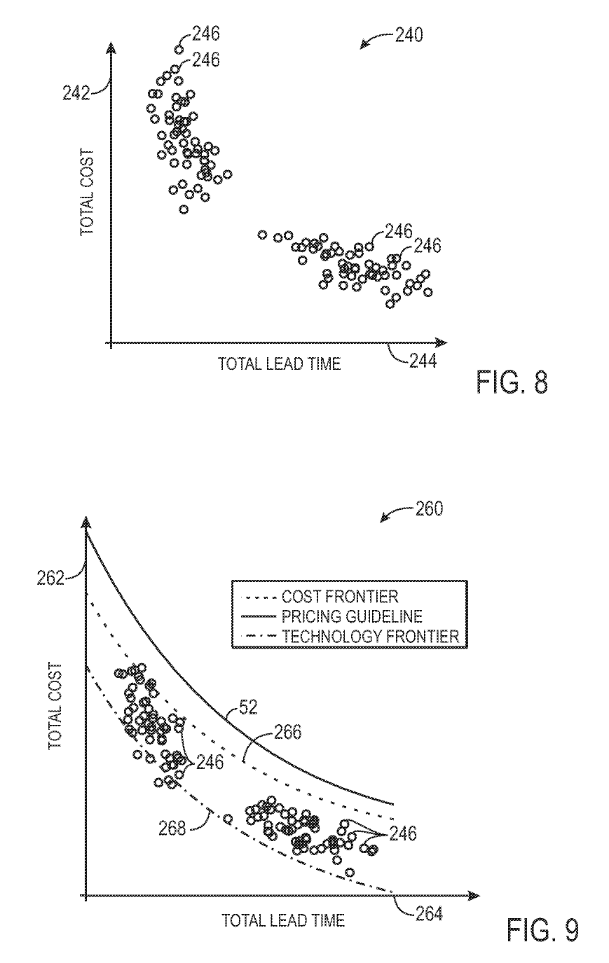

By summing the costs 220 and lead times 222 for each fulfillment path, all possible total costs and lead times may be determined, as generally mentioned above with reference to block 68 of FIG. 3. As shown by a plot 240 of FIG. 8, the pricing system 22 may compare the total costs and lead times of these various fulfillment paths that may be taken to fulfill the print order 16. In the plot 240, an ordinate 242 represents total costs and an abscissa 244 represents total lead times. Data points 246 represents total costs and total lead times associated with the various possible fulfillment paths.

To provide one example, each data point 246 may be generated by the pricing system 22 according to the following procedure. The pricing system 22 first may consider all of the print products 94 requested by the print order 16 and, for each print product 94, may walk through the determined requisite tasks 190. For each requisite task 190, the pricing system 22 may choose one qualified resource 212 from the resource pool associated with that task 190, adding its particular cost 220 and lead time 222 to a total end-to-end cost and lead time. When there are parallel procedures, the highest lead time may be counted. As such, the total end-to-end cost to fulfill all of the print products 94 through the fulfillment path are summed together as the total cost for the print order 16, and the maximum lead time to manufacture one of the print products 94 will be considered the lead time for the print order 16. The resulting cost and lead time together then define one data point 246 in the plot 240.

The aforementioned procedure for determining one data point 246 may be carried out for all possible combinations of the resource pool of qualified resources 212 associated with each task 190, in addition to possible variations of priority policy for the print order 16. Each combination generates one data point 246. That is, each data point 246 corresponds to one possible fulfillment path and priority for fulfilling the print order 16.

From such a comparison of costs and lead times for all possible fulfillment paths through the PSP 14 for a print order 16, as generally represented by the plot 240 of FIG. 8, the pricing system 22 may determine a pricing guideline 52. As noted above, the pricing guideline 52 may assist a human or automated negotiator to determine the price and lead time pair 20 associated with the agreement 18. By way of example, as shown by a plot 260 of FIG. 9, the pricing guideline 52 may be determined by observing the comparison of the possible fulfillment paths (e.g., as shown by the plot 240 of FIG. 8). In the plot 260, an ordinate 262 represents cost an abscissa 264 represents total lead time for a fulfillment path to fulfill the print order 16. It may be noted that the data points 246 representing the costs and lead times associated with possible fulfillment paths tend to cluster at two regions: a higher cost, but shorter lead time region corresponding to high priority, and a lower cost, but longer lead time region corresponding to normal priority.

A cost frontier curve 266 can be derived based on the data points 246. This cost frontier curve 266 captures the maximum cost when the PSP 14 promises a certain delivery time as indicated by the cost frontier curve 266. In addition, the profit markup factor (e.g., price versus cost ratio) can be derived from a demand side investigation. Therefore the pricing guideline 52 can be derived, as shown in FIG. 9. The cost frontier curve 266 and pricing guideline 52 can assist both the PSP 14 and/or the customer 12 to make informed decisions on pricing and expected delivery times.

It should further be appreciated that a technology frontier 268 becomes apparent in the plot 260. The technology frontier 268 represents the most cost-effective way of fulfilling the print order 16 using the print service resources 224 of the PSP 14. Thus, the PSP 14 should select those fulfillment path options represented by the data points 246 that are closest to the technology frontier 268.

Indeed, by doing so, a pricing system such as disclosed herein may provide technical effects that include improved efficiency for fulfillment of print orders by print service providers (PSPs). In addition, such a pricing system may provide quantitative pricing and lead time guidance to enable the PSP to more easily and appropriately negotiate a price and due time for a print order. Negotiating such a price and due time pair and using an efficient fulfillment path, as provided by the pricing system disclosed herein, may also result in greater profit to the PSP and/or lower prices for the customer.

What is claimed is:

1. A method comprising:
receiving into an electronic device a print order from a customer to a print service provider;
determining in the electronic device requisite tasks to fulfill the print order;
determining in the electronic device which resources of the print service provider are capable of undertaking the requisite tasks; and
determining in the electronic device respective costs and lead times associated with undertaking each requisite task using each capable resource based at least in part on a dynamic behavioral model of cost and a dynamic behavioral model of lead time associated with each resource.

2. The method of claim 1, comprising determining in the electronic device total costs and total lead times respectively associated with each possible path to fulfillment of the print order through the capable resources based at least in part on the respective costs and lead times associated with undertaking each requisite task using each capable resource.

3. The method of claim 2, comprising determining in the electronic device a price and due time expected to be acceptable to both the customer and the print service provider based at least in part on a comparison between the total costs and total lead times respectively associated with each possible path to fulfillment.

4. A system comprising:
a network interface or an input/output interface, or a combination thereof, at least collectively configured to receive a print order and a resource usage status associated with a resource of a print service provider at a site of the print service provider; and
data processing circuitry configured to determine requisite tasks to fulfill the print order and determine a cost and a lead time associated with performing one of the requisite tasks using the resource based at least in part on a behavioral model of cost, a behavioral model of lead time, and the resource usage status.

5. The system of claim 4, wherein the resource usage status comprises a current level of utilization of the resource or a size of a waiting queue of the resource, or a combination thereof.

6. The system of claim 4, wherein the resource usage status comprises a determination of resource usage status based at least in part on a measurement of a state of the resource, an estimate of resource usage status based at least in part on a simulation of the resource, an estimate of resource usage based at least in part on an industry information database, an estimate of resource usage status based at least in part on a dynamic forecasting model of the resource, or an estimate of resource usage status based at least in part on analyzing and extrapolating from historical data, or any combination thereof.

7. The system of claim 4, wherein the behavioral model of cost is based at least in part on a work time required to perform the requisite task using the resource, a worker cost rate associated with operating the resource to perform the requisite task using the resource, a non-worker cost rate required to operate the resource to perform the requisite task using the resource, and a faulty rate of the resource that is dependent on the resource usage status.

8. The system of claim 4, wherein the behavioral model of cost is based at least in part on the following relationship:
Cost(*)=work_time*(rate_cost+worker_demand*rate_cost_worker)*(1+faulty_rate)
where Cost(*) represents a cost to perform the requisite task using the resource, work_time represents a work time required to perform the requisite task using the resource, rate_cost represents a non-worker cost rate required to operate the resource to perform the requisite task using the resource, worker_demand represents a proportion of a worker's time required to perform the requisite task using the resource, rate_cost_worker represents a worker cost rate associated with operating the resource to perform the requisite task using the resource, and faulty_rate represents a faulty rate of the resource that is dependent on the resource usage status.

9. The system of claim 4, wherein the behavioral model of cost is based at least in part on a work time required to perform the requisite task using the resource, a worker cost rate associated with operating the resource to perform the requisite task, a non-worker cost rate required to operate the resource to perform the requisite task, an opportunity cost that is dependent on the resource usage status, a faulty rate of the resource that is dependent on the resource usage status, and a perceived risk or an effect of a random event, or both.

10. The system of claim 4, wherein the behavioral model of cost is based at least in part on the following relationship:
$$Cost ( \text{*} ) = work\_time * ( \begin{matrix}rate\_cost + worker\_demand * rate\_cost \_worker + \\ rate\_opportunity \_cost * size\_of \_waiting \_queue\end{matrix} ) * ( 1 + faulty\_rate ) ,$$
where Cost(*) represents a cost to perform the requisite task using the resource, work_time represents a work time required to perform the requisite task using the resource, rate_cost represents a non-worker cost rate required to operate the resource to perform the requisite task using the resource, worker_demand represents a proportion of a worker's time required to perform the requisite task using the resource, rate_cost_worker represents a worker cost rate associated with operating the resource to perform the requisite task using the resource, rate_opportunity_cost represents an opportunity cost that is dependent on the resource usage status, size_of_waiting_queue represents a size of a waiting queue of the resource as indicated by the resource usage status, and faulty_rate represents a faulty rate of the resource that is dependent on the resource usage status.

11. The system of claim 4, wherein the behavioral model of lead time is based at least in part on a non-linear function relating a wait time representing time spent waiting in a queue of other jobs to be carried out by the resource before the resource begins to work on the requisite task and the resource usage status.

12. The system of claim 4, wherein the behavioral model of lead time is based at least in part on the following relationship:
Lead_time(*)=wait_time+work_time*(1+faulty_rate)
where Lead_time(*) represents a lead time to complete the requisite task using the resource, wait_time represents a time waiting behind a queue of other jobs to be carried out by the resource, work_time represents a work time required to perform the requisite task using the resource, and faulty_rate represents a faulty rate of the resource that is dependent on the resource usage status.

13. An article of manufacture comprising:
at least one tangible machine-readable medium at least collectively storing instructions executable by a processor of an electronic device, the instructions comprising:
instructions to receive a print order;
instructions to determine requisite tasks to fulfill the print order;
instructions to determine, for each requisite task, a resource pool of print shop resources that respectively would be capable of performing that requisite task;
instructions to determine, for each resource of each resource pool associated with each requisite task, a cost and a lead time associated with performing that requisite task using that resource based at least in part on a behavioral model of cost associated with that resource and a behavioral model of lead time associated with that resource; and
instructions to sum the costs and lead times associated with a plurality of possible fulfillment paths that would perform all of the requisite tasks using respective permutations of the resources of the resource pools associated with each requisite task to determine a plurality of possible total costs and possible total lead times associated with fulfilling the print order.

14. The article of manufacture of claim 13, wherein the instructions to receive the print order comprise instructions to receive an indication of fulfillment intent and wherein the instructions to determine requisite tasks comprises instructions to determine a description and a minimum level of quality associated with each task that accords with the fulfillment intent.

15. The article of manufacture of claim 13, comprising instructions to determine a pricing guideline, a cost frontier, or a technology frontier, or a combination thereof based at least in part on a comparison between the total costs and total lead times respectively associated with the plurality of possible fulfillment paths.
